(19) United States
(12) Patent Application Publication
(10) Pub. No.: US 2015/0128499 A1
(43) Pub. Date: May 14, 2015

(54) Universal Energy Accumulator

(71) Applicant: DORMA Deutschland GmbH, Ennepetal (DE)

(72) Inventor: Alexander HELLWIG, Ennepetal (DE)

(21) Appl. No.: 14/538,031

(22) Filed: Nov. 11, 2014

(30) Foreign Application Priority Data
Nov. 11, 2013 (DE) 102013112379.1

(51) Int. Cl. E05F 15/00; E05B 65/10; E05F 15/04; E05F 15/20

(52) U.S. Cl. CPC E05F 15/0004; E05F 15/2015; E05B 65/10; E05F 15/04
USPC 49/358

(57) ABSTRACT

A door operator, including a housing, a drive element for storing closing and opening energy for a door leaf, and a drive unit, including at least one piston, which unit can be coupled to the door leaf, where the drive element comprises at least one elastically deformable element, which is disposed on a push rod which is in operative connection with the piston.

### CROSS REFERENCE TO RELATED APPLICATION

This application is related to and claims the benefit of German Patent Application Number 102013112379.1 filed on 11 Nov. 2013, the contents of which are herein incorporated by reference in their entirety.

### TECHNICAL FIELD

The invention relates to a door operator, comprising a housing, a drive element for storing closing and opening energy for a door leaf, and a drive unit including at least one a piston, which can be coupled to the door leaf.

### BACKGROUND

Door operators are integral parts of modern building engineering and therefore they must comply with existing safety regulations. In particular on the condition that the door operator is disposed at a door which is located in an escape route of the building, a door operator has to meet considerable safety requirements.

In this case, in particular a reliable functioning of the door operator is emphasized, if an emergency situation prevails in said building. This situation may occur for example in case of a fire, a power failure or any other event.

In particular in the event of a fire, the door operators must meet special requirements, such that the trouble-free continued operation of the door operator is guaranteed. If the door operator is configured as an electrical door drive, in the event of a power failure, the door leaf still needs to be at least manually operable.

Usually, door operators can be configured as door closers of manually or electrically operated door drives, in order on the hand the door closes automatically, respectively in case of a power failure, the closing movement of the electrical door drive is performed by the door closer. The known door operators are equipped for this purposes usually with a spring energy accumulator, in which a potential energy can be stored, which energy originates from the manually or electrically performed opening movement of the door leaf. This energy is sufficient for subsequently performing a closing movement of the door leaf.

The known spring energy accumulators for a door operator are disadvantageous in that the introduction of force, respectively the discharge of force thereof is realized asymmetrically, moreover they are normally configured as a special component for one product only, and in addition they are subject to tolerances.

### BRIEF SUMMARY

The invention overcomes the disadvantages of the state-of-the-art and in particular to further improve variable component parts for and the comfort of door operators.

The problem is solved based on a door operator, comprising a housing, a drive element for storing closing and opening energy for a door leaf, and a drive unit including at least one piston, which can be coupled to the door leaf.

The invention includes the technical teaching that the drive element comprises at least one elastically deformable element, which is disposed on a push rod which is in operative connection with the piston.

The inventive door operator may be configured as a mechanical door closer or as an electrically operated door drive. In this case, the door operator includes a drive element in the shape of a universal energy accumulator as an essential component, which, according to the invention, comprises at least one elastically deformable element disposed on the push rod. The drive element differs from the known spring energy accumulators in that accumulating the energy is realized by means of the elastic deformation of the elastically deformable element, which deformation is decisively determined by the characteristics of the materials of the element, namely the composition thereof.

In order to be able to accumulate the energy, respectively to retrieve it, the elastically deformable element must not only be able to transform from its original form into the deformed form, but also the energy, which is required for the transformation must be able to be retrieved. Advantageously, for this purpose the elastically deformable element abuts partially at the housing of the door operator such that the transformation of the elastically deformable element is realized by the movement of the push rod in the longitudinal extension of the push rod.

When moving the door leaf, for example in the opening position thereof, the push rod, on which the elastically deformable element is disposed, is advantageously moved by the drive unit of the door operator, which unit is coupled to the door leaf, in the direction of the longitudinal extension of the push rod, wherein the elastically deformable element can only follow this movement by transforming in the longitudinal extension of the push rod, because the element is pressed against the housing. The force, which has been deployed for the transformation of the elastically deformable element is accumulated in this case as energy in the transformed elastically deformable element. In this case, the accumulated energy is dimensioned such that, upon decompressing the elastically deformable element, the thus released energy is sufficient to automatically close the door leaf again. In this case, the energy is transferred in the opposite direction, i.e. from the elastically deformable element onto the push rod and from the push rod by means of the movement thereof in the longitudinal extension thereof, in the opposite direction of the above described movement of the push rod, onto the drive unit and from there onto the door leaf. This procedure ensures an appropriately centered spring effect of the door operator.

Advantageously, the elastically deformable element may be disposed in a sleeve, which, at least in sections, surrounds the elastically deformable element, and with which the elastically deformable element is placed into the housing of the door operator. This configuration is in particular advantageous in case several elastically deformable elements are disposed in a cascade like manner, i.e. one after the other, on the push rod. In this configuration, the drive element, which comprises the elastically deformable elements disposed in the sleeve, can be placed into the housing, literally seen like a battery is placed into a battery compartment. Furthermore advantageously, the housing includes at least one opening, which accommodates the sleeve. In case of several sleeves, advantageously several openings corresponding to the number of the sleeves are provided in the housing.

The sleeve can be advantageously manufactured from a plastic material, from a metal or from a metal alloy. Obviously, it is also conceivable to use various materials or a mix of materials in the drive element. In this case, the material, respectively the walling of the sleeve is preferably designed, respectively dimensioned in that the sleeve is not destroyed during deformation of the elastically deformable element and the thereby occurring force.

In case the sleeve forms, at least in sections, a portion of the housing, it is advantageous, if the sleeve is manufactured from the same material as the housing. If the housing is for example an injection-molded part or a sheet metal part, it is suggested to manufacture the sleeve from these materials as well, in particular when considering for example the mechanical and flame-resisting properties of the housing. Obviously, the sleeve may be manufactured deliberately from a different material than the housing. This consideration could be conceivable for example in terms of cost reduction when manufacturing the housing, wherein the sleeve could be manufactured for example from a less expensive material than the housing material. In case of a multi-part housing of the door operator, the sleeve could be formed for example as a part of the multi-part housing such that, when assembling the housing, the elastically deformable element, which is disposed in the sleeve, would be installed as well, whereby another operational step would be saved during the manufacturing process of the door operator.

Advantageously, with the intention to adjust, respectively to increase the energy to be accumulated, several elastically deformable elements are disposed in a row on the push rod. In this case, the number of elastically deformable elements and the material features thereof can be tailored to the needs, i.e. to the closing, respectively opening energy to be deployed, which is to be deployed for closing respectively opening any given door leaf.

Obviously, it is also conceivable, to utilize the inventive elastically deformable elements in combination with the known spring energy accumulators as energy storage mechanism. In this case, for example one or more inventive elastically deformable elements could assist a spring which is installed in a door operator and has a spring force, which due to material wear and tear is insufficient for storing the energy which is to be deployed for closing, respectively opening a door leaf.

The elastically deformable element is preferably a rubber-elastically deformable element. For this purpose, the elastically deformable element can be preferably manufactured from the group of materials comprising plastic materials, elastomers, rubbers, caoutchuc or silicone rubber or a combination of the materials of plastic materials, elastomers, rubbers, caoutchouc or silicone rubber. Obviously, the materials or the combinations thereof may preferably have a flame-resistant behavior, wherein the elastically deformable features of such plastic materials should be essentially maintained despite the flame-resistant features.

Preferably, the material features of the elastically deformable element may be likewise modified by means of the process of cross-linking when manufacturing the elastically deformable element from the material comprising plastic materials, elastomers, rubbers, caoutchouc or silicone rubber or a combination of the materials of plastic materials, elastomers, rubbers, caoutchouc or silicone rubber. In this case, an increase in the hardness, the viscosity, the melting point and a reduction of the solubility can be set for example by modifying the degree of cross-linking. In this case, preferably the modification increases with the degree of cross-linking and the proportion of the cross-linked locations in relation to the overall polymer amount.

A modification of the material features of the elastically deformable element may be likewise achieved by means of adding softening agents when manufacturing the elastically deformable element from the materials comprising plastic materials, elastomers, rubbers, caoutchouc or silicone rubber or a combination of the materials of plastic materials, elastomers, rubbers, caoutchouc or silicone rubber.

Thus, by means of different materials, preferably different elastic deformations, i.e. corresponding different spring characteristics can be achieved.

Preferably, the elastically deformable element abuts at a spacer sleeve in longitudinal extension of the push rod. The spacer sleeve is preferably configured in such a way that the spacer sleeve is accommodated non-positively and/or positively in an opening of the elastically deformable element. However, the size of the support surface for the elastically deformable element, which surface is formed by the spacer sleeve, is decisive for the setting of the spring characteristics. Therefore, in the extreme case, the spacer sleeve could have the same circumference as the elastically deformable element, such that the elastically deformable element could fully abut against the spacer sleeve. However, it is likewise conceivable to configure the spacer sleeve with a smaller circumference than the one of the elastically deformable element. This is advantageous in that the elastically deformable element can accommodate the spacer sleeve in the opening and thereby surrounds the spacer sleeve at least in sections. In particular when cascading several elastically deformable elements with spacer sleeves disposed between the elastically deformable elements, different circumferences of the spacer sleeve and of the elastically deformable element simplify the compartment building of the push rod. Advantageously, for example two elastically deformable elements can thereby be prevented from being inadvertently disposed adjacent to each other on the push rod without an intermediate spacer sleeve. However, a disposition on the push rod of two or more elastically deformable elements adjacent each other, is thereby not excluded.

In case several spacer sleeves are utilized between several elastically deformable elements, advantageously, the spring characteristics of the door operator can be additionally adjusted by means of the distances of the spacer sleeves to each other and/or to the elastically deformable elements.

Advantageously, the spacer sleeve and/or the elastically deformable element may be manufactured from an adaptive material. Preferably, for example the spacer sleeve may be filled with a rheologic fluid, for example an electro-rheologic liquid, which can be controlled depending on its states, in order to further affect, respectively adjust the spring characteristics of the inventive door operator. Obviously other rheologic fluids, such as magneto-, chemo-, or thermo-rheologic fluids can be used for filling the spacer sleeves.

The geometrical shape of the elastically deformable elements, as well as the geometrical shape of the sleeve or the spacer sleeves may preferably serve for adjusting the spring characteristics. In this case, advantageously the elastically deformable element is configured as a ring, respectively as a disc, which circumferentially fully surrounds the push rod. However, it is likewise possible to provide for example an elastically deformable element which surrounds the push rod only in sections, and which abuts at the housing, respectively against the sleeves or spacer sleeves, only in the area of its section-wise configuration. Thus for example an elastically deformable element surrounding only half of the push rod for example could abut only against the upper or lower portion, respectively at the frontal or rear portion of the housing and/or the sleeve or the spacer sleeves.

The elastically deformable element could likewise be formed in the shape of a polygon, for example in the shape of a rectangle or a triangle, wherein only the corners of the polygon would abut at the housing, respectively at the sleeve surrounding the elastically deformable element.

However, it is likewise conceivable to configure the circumference of the elastically deformable element in that the latter, without the effect of force via the push rod, does not bear against the housing of the door operator and will only reach abutment at the housing after a predetermined movement of the push rod in the longitudinal extension thereof, i.e. after a predetermined action of forces.

Obviously, the described elastically deformable elements may be employed in any combination for adjusting the spring characteristics of the door operator.

The push rod, on which at least the elastically deformable element and, as needed, also the spacer sleeve is disposed, may be advantageously configured as one piece or in several pieces. li is particularly preferred that the push rod comprises a spacer element, or that the push rod is integrally configured with the spacer element, wherein the push rod or the spacer element includes a groove or recess, in order to accommodate the elastically deformable element as well as the spacer sleeve in a centered manner. In this case, the spacer element with the elastically deformable element disposed thereon and the spacer sleeve preferably forms a section of a multi-part push rod. In this case, the spacer element is configured in that the latter, in the longitudinal extension of the push rod, can be coupled to another spacer element or to several spacer elements, i.e. can be mounted like a cascade, whereby preferably the size, i.e. the length of the push rod can be freely selected.

With the intention to be able further simplify manufacturing of the door operator with the inventive drive element even more, the elastically deformable element and/or the spacer sleeve is advantageously vulcanized into or glued to the groove or the recess of the push rod or of the spacer element in such a way that the push rod or the spacer element together with the spacer sleeve and the elastically deformable element form one structural unit, i.e. one structural part, which, on its own or in multiples thereof placed one after the other, respectively one fitted into the other, form the push rod.

In case the push rod is formed from several spacer elements placed one after the other, respectively one fitted into the other, they preferably constitute an integral part of the push rod. With the intention to guarantee sufficient strength of the spacer elements, they can be preferably made from metal or from a metal allow in an injection-molding process. Obviously, it is likewise conceivable to manufacture the push rod or the spacer elements, which are preferably integrally configured with the push rod, from a plastic material.

Advantageously, the load on the door operator can be optionally utilized while pulling or while pushing. This means that the energy, which has been stored in the elastically deformable element by means of the action of forces, could be optionally used for opening or for closing for example a door leaf.

### BRIEF DESCRIPTION OF THE DRAWINGS

Hereinafter, further measures enhancing the invention will be illustrated in detail in conjunction with the description of one preferred embodiment of the invention based on the Figures, in which:

FIG. 1: shows a sectional view of an inventive door operator with drive element,

FIG. 2: shows a detailed view of a section B of FIG. 1, and

FIG. 3: shows a side view of a drive element with sleeve.

### DETAILED DESCRIPTION

Throughout the different Figures, same parts are always identified by the same reference numerals, and therefore they will be normally only described once.

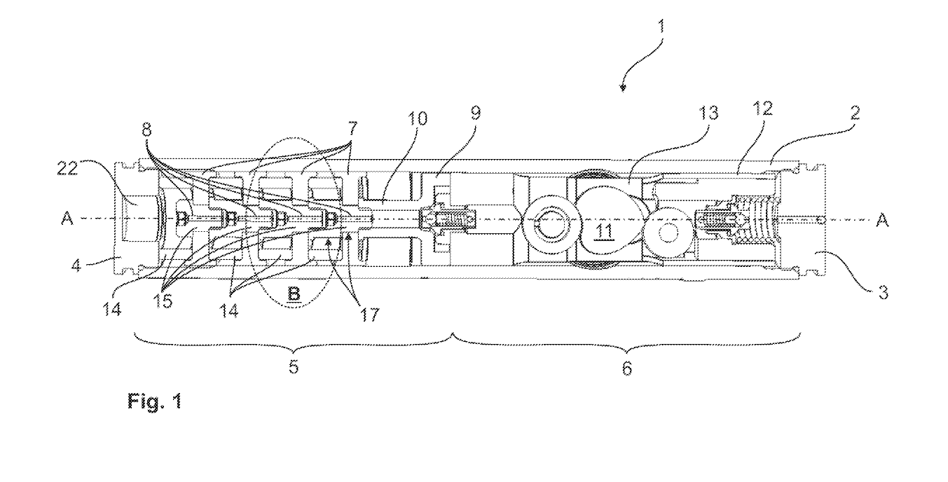

In the following, a door operator, which essentially includes a drive unit and a drive element and is configured as a door closer, is explained in detail in FIG. 1.

As the individual structural parts of the drive unit 6 of the door operator 1 are not relevant for the explanation of the invention, only the essential elements of the drive unit 6 will be identified and are intended to help understanding. Thus, the functioning of the drive unit 6 and of the inventive door operator 1 is not affected at all.

FIG. 1 shows the door operator 1. The door operator 1 comprises an essentially cylindrically shaped housing 2. The two side ends of the housing 2 are closed off by means of a first cover 3 and a second cover 4.

The drive unit 6 is disposed in the right hand part of the housing 2, the end thereof being closed off by the first cover 3. A cam disc 11 is disposed in the center of the drive unit 6. The cam disc 11 is connected in a torque-proof manner to a non-illustrated drive shaft. An arm assembly for example will be attached to said drive shaft. The force is transmitted via said arm assembly onto the door leaf, respectively onto the wall or the door casing.

An opening piston 9 is located on one side of the cam disc 6. The opening piston 9 is supported in the housing 2 to be linearly movable along the virtual axis A-A. For this purpose, the envelope surface of the opening piston 9 bears against the interior walling of the housing 2. A cylinder element 12 is disposed on the other side of the cam disc 11. The cylinder element 12 is securely connected to the opening piston 9 via webs 13. In particular the opening piston 9, the cylinder element 12 and the webs 13 are integrally manufactured together.

The drive element 5 is located on the side of the opening piston 9 facing away from the cam disc 11. The drive element 5 comprises several elastically deformable elements 7 which are organized one after the other, disposed on a push rod 8 and spaced apart by means of spacer sleeves 14. Both the elastically deformable elements 7 and the spacer sleeves 14 are received in grooves, respectively recesses 17 of spacer elements 15 which are disposed on the push rod 8. In the present case, the push rod 8 is composed of multiple parts, wherein one part of the push rod 8 is assigned to each elastically deformable element 7, each spacer sleeve 14 and each spacer element 15, wherein respectively one elastically deformable element 7, one spacer sleeve 14 and one spacer element 15 together form one push rod compartment 23. Thus, in its longitudinal extension, i.e. along the virtual axis A-A, the push rod 8 is formed by lining-up, respectively by cascading the push rod compartments 23.

It is via a piston rod 10 that the opening piston 9 is operatively connected to the push rod 8. When moving the opening piston 9, the push rod 8 is moved via the piston rod 10 or reversed, the opening piston 9 is moved via the piston rod 10 by means of the push rod 8. If the movement of the push rod 8 is starting at the opening piston 9 by means of the drive unit 5, the piston rod 10 moves in the direction of the second cover 4. For this purpose, the cover 4 has a plunge area 22, which at least corresponds to the maximum lift, respectively to the piston displacement of the piston rod 10.

As already described, the cam disc 11 is connected to the drive shaft in a torque-proof manner or else integrally configured with the drive shaft. By opening for example the door leaf, the output shaft is entrained into rotation. Thereby, the cam disc 11 rotates as well. In this case, in the position illustrated in FIG. 1, the cam disc 11 pushes the opening piston 9 to the left. Thereby, the push rod 8, which is operatively connected to the piston rod 10, is likewise pushed to the left by means of the piston rod 10. The elastically deformable elements 7, which are disposed on the push rod 8 and abut at the housing 2, are deformed by the movement of the push rod 8. The force, deployed for the transformation of the elastically deformable elements 7, is accumulated in the shape of transformation energy in the elastically deformable elements 7. In addition, the transformation of the elastically deformable elements ensures the centered spring effect of the drive element 5.

The transformation energy, which has been accumulated in the transformed elastically deformable elements 7, will be utilized for the closing operation of the door leaf, because the transformed elastically deformable elements 7 revert back to their original shape. The force resulting therefrom pushes, via the push rod 8 and the piston rod 10, the opening piston 9 to the right. The cam disc 11 and thereby the output shaft, which is connected in a torque-proof manner to the cam disc, are thereby entrained into rotation leading to closing the door leaf.

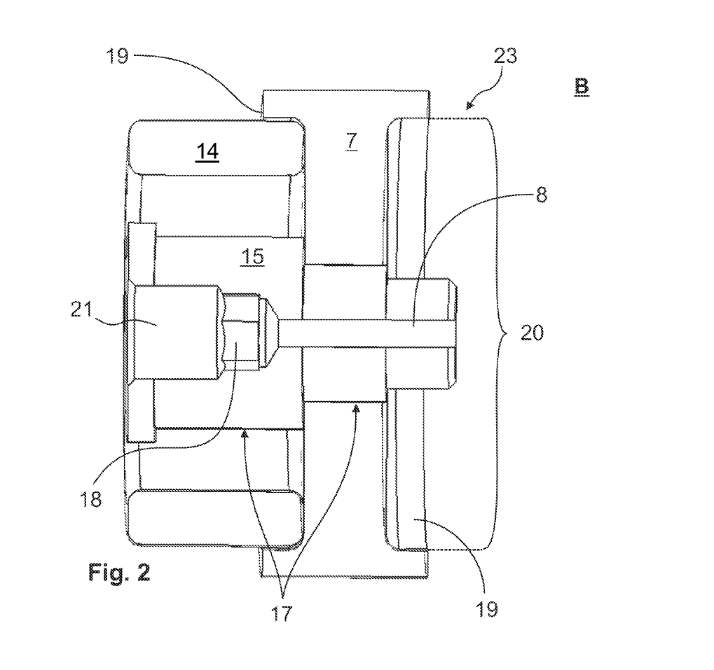

As illustrated in FIG. 1 and in the detailed view of the section B in FIG. 2, each part of the push rod 8 comprises a push rod compartment 23, which respectively comprises one elastically deformable element 7, one spacer sleeve 14 and one spacer element 15. In this case, the elastically deformable element 7, the spacer sleeve 14 and the spacer element 15 are disposed on a push rod 8. In the present case, the spacer element 15 preferably forms one part of the push rod 8, i.e. the push rod 8 is integrally configured with the spacer element 15. With the intention to dispose the elastically deformable elements 7 and the spacer sleeve 14 in the center, the spacer element 15 includes grooves, respectively recesses 17, to which the elastically deformable element 7 is glued or into which the latter can be vulcanized.

As can be seen in FIG. 2, the elastically deformable element 7 forms radially surrounding frontal surfaces protruding on both sides beyond the border 19, which encloses an opening 20. In this case, the opening 20 is dimensioned such that the spacer sleeve 14 can be disposed in the latter, at least in sections. In this case, the border 19 formed by the elastically deformable element 7 projects in sections beyond the spacer sleeve 14. Thus, the elastically deformable element 7 and the spacer sleeve 14 are configured in such a way that they can be pushed, respectively fitted into each other.

The push rod 8, respectively the spacer element 15 comprises a coupling element 21 and an anchoring element 18. The coupling element 21 serves for positively receiving another push rod compartment 23, that means for organizing them one after the other. It is the anchoring element 18, which in the present case is configured as a union nut and couples together the two push rod compartments 23 and positively connects them to each other.

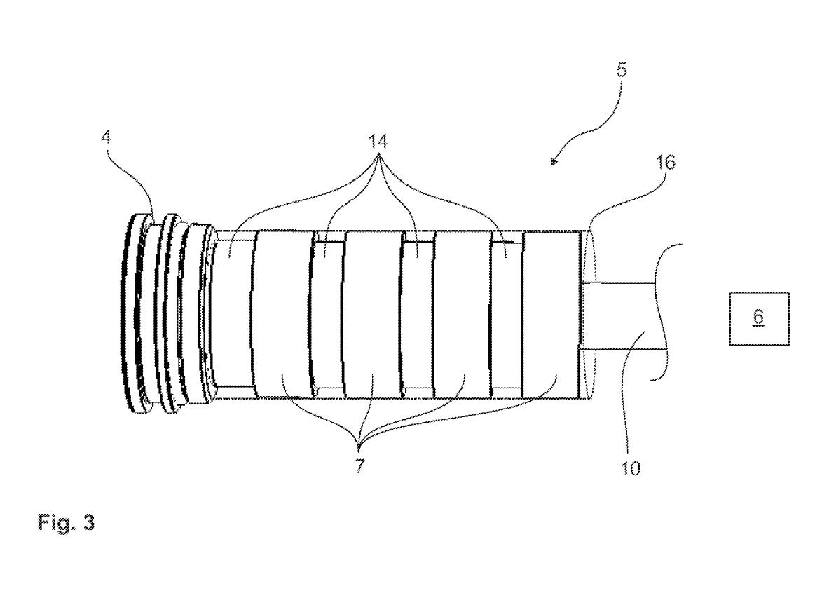

FIG. 3 shows a lateral view of the drive element 5, which comprises several push rod compartments 23 organized on after the other, that means disposed in a cascading manner, and which is operatively connected to a drive unit 6 via a piston rod 10. The push rod compartments 23 are encased by a sleeve 16, which is schematically illustrated by a dotted line. In this case, the sleeve 16 can be a part of the housing 2 of the door operator 1 or can replace the latter at least partially. Thanks to the encasing, respectively enclosing, at least in sections, of the drive element 5 with a sleeve 16, the element, as one structural part, i.e. as a module, can be placed into the housing 2 of the door operator 1, respectively incorporated into the housing 2.

On account of various definitions of the discussed components, respectively the numbers thereof, within the framework of a standardized building block or building kit concept, it is possible to achieve different spring characteristics of the door operator 1 with like components which are differently combined.

The invention in its configuration is not limited to the above presented preferred embodiment, respectively to the possibly described method steps. On the contrary, a number of variants are conceivable, which make use of the illustrated solution, even with basically different types of embodiments. All features and/or advantages including the constructional details, spatial dispositions and possible method steps, which result from the claims, the description or the drawings, may be essential to the invention, both by themselves and in their most various combinations.

1. A door operator, comprising a housing, a drive element for storing closing and opening energy for a door leaf, and a drive unit, including at least one piston, which can be coupled to the door leaf, wherein the drive element comprises at least one elastically deformable element, which is disposed on a push rod, which is in operative connection with the piston.

2. The door operator according to claim 1, wherein the elastically deformable element abuts, at least in sections, at the housing.

3. The door operator according to claim 1, wherein the elastically deformable element is rubber-elastically deformable.

4. The door operator according to claim 1, wherein the elastically deformable element can be manufactured from materials comprising at least one of plastic materials, elastomers, rubbers, caoutchuc or silicone rubber or a combination of the materials of plastic materials, elastomers, rubbers, caoutchuc or silicone rubber.

5. The door operator according to claim 1, wherein the elastically deformable element is disposed in a sleeve.

6. The door operator according to claim 5, wherein the sleeve, at least in sections, is a part of the housing.

7. The door operator according to claim 5, wherein the sleeve is disposed in an opening of the housing.

8. The door operator according to claim 5, wherein the sleeve can be manufactured from a plastic material.

9. The door operator according to claim 1, wherein the push rod is configured as a single part or in multiple parts.

10. The door operator according to claim 1, wherein the push rod includes at least one groove or recess, at which at least the elastically deformable element can be disposed in the centre.

11. The door operator according to claim 10, wherein the elastically deformable element is vulcanized and/or glued into the groove or the recess.

12. The door operator according to claim 1, wherein the elastically deformable element is configured in a ring-shape.

13. The door operator according to claim 1, wherein the push rod is movable in the direction of a longitudinal extension and the elastically deformable element can be deformed by the movement of the push rod.

14. The door operator according to claim 1 having at least two elastically deformable elements, wherein the elastically deformable elements are spaced apart from each other by means of at least one spacer sleeve.

15. The door operator according to claim 14, wherein the elastically deformable element can be, at least partially, non-positively and/or positively brought into engagement with the spacer sleeve.

16. The door operator according to claim 15, wherein the engagement is realized such that the elastically deformable element, at least in sections, abuts at the spacer sleeve.

17. The door operator according to claim 1, wherein the spacer sleeve and the elastically deformable element surround a spacer element, which is disposed on the push rod and/or which is configured integrally with the push rod, and/or which, in the longitudinal extension of the push rod, can be arranged like a cascade with at least one other spacer element.

18. A kit, including elastically deformable elements and/or at least one spacer sleeve, in particular one elastically deformable element and/or one spacer sleeve according to claim 1, for composing a drive element having adjustable spring characteristics.
